(19) United States
(12) Patent Application Publication
(10) Pub. No.: US 2018/0355514 A1
(43) Pub. Date: Dec. 13, 2018

(54) METHOD FOR ENCODING AND DECODING LARGE SCALE MOLECULAR VIRTUAL LIBRARIES INTO A BARCODE

(71) Applicant: Council of Scientific & Industrial Research, New Delhi (IN)

(72) Inventors: Muthukumarasamy Karthikeyan, Pune (IN); Deepak Karbhari Pandit, Pune (IN)

(73) Assignee: Council of Scientific & Industrial Research, New Delhi (IN)

(21) Appl. No.: 15/573,352

(22) PCT Filed: May 11, 2016
(86) PCT No.: PCT/IN2016/050134

§ 371 Date: Nov. 10, 2017

(30) Foreign Application Priority Data
May 12, 2015 (IN) 1325/DEL/2015

(51) Int. Cl. C40B 30/02; C40B 50/02; G06F 19/00

(52) U.S. Cl. CPC C40B 30/02; G06F 19/701; C40B 50/02

(57) ABSTRACT

Method for encoding and decoding large scale molecular virtual libraries into a barcode Ligand-based drug discovery is often characterized with extraction of scaffolds, linkers and 5 building blocks from large small molecule datasets. Variable sites on scaffolds with attachment sites on building blocks participate in a combinatorial virtual reaction to generate a set of new virtual molecules. This process is time consuming and demands more storage space and is tedious to exchange data digitally. There is practically no quick way to sample molecules without enumerating the virtual library. Therefore, the present invention discloses a method of 10 encoding a virtual library of large scale molecular data into a single barcode. The present invention further discloses a method of decoding the barcode containing large scale data molecules.

### FIELD OF INVENTION

The present invention relates to a method of encoding and decoding the large scale data of molecular structures and virtual libraries into a barcode.

### BACKGROUND & PRIOR ART

Searching, retrieving and maintaining huge compound libraries can be daunting tasks in chemoinformatics. Public repositories for lead based drug discovery such as Pubchem, Chemspider, and ZINC collate information on both natural products and synthetic compounds and serve as important data sources. As mentioned in the publication with Pubmed ID: 20981528, storage, enumeration and reusability has also been the major concern over maintaining virtual libraries and underlying synthetic feasibility as is discussed in connection to Pfizer Global Virtual Library (hereafter referred to as PGVL), a library of 10 raise to 13 readily synthesizable molecules. It has accumulated over one million compounds and 3000 parallel synthesis protocols categorized into more than 1000 virtual reactions. Such large size cannot utilize standard molecular similarity search approaches when many chemical information systems are capable of handling only 10 raise to 8 explicit molecules only. Various attempts to address this problem were made to focus on sub-region of full virtual space by using PGVL reaction knowledge and reactant level similarities. Focused libraries dynamically generated from large libraries recursively makes enumeration of diverse set of natural product-like and drug-like compounds feasible. Essentially, there is a need to explore ways for reducing combinatorial space through designing focused virtual library and may be through compact representation transitionally.

Looking for compact representation, barcodes become natural choice which represents information in a symbolic way but most importantly in a way to be decoded automatically through scanners. Early ideas of barcode were conceived with the introduction of UPC (Universal Product Code) and later evolved to accommodate more data.

US2013130255 discloses a method of barcoding single DNA molecule. This barcode has a maximum achievable resolution of less than 20 bases, which can be read and analyzed like a standard barcode. The method generates a fluorocode for genomic DNA from the lambda bacteriophage using a DNA methyltransferase to direct fluorescent labels to four-base sequences reading 5′-GCGC-3′. A consensus fluorocode is constructed that allows the study of the DNA sequence at the level of an individual labeling site and is generated from a handful of molecules and entirely independent of any reference sequence. However, there is no mention of which barcode has been used while decoding genomic DNA.

U.S. Pat. No. 8,481,699 discloses multiplex barcoded Paired-End Ditag (mbPED) library construction for ultra high throughput sequencing. The mbPED library comprises multiple types of barcoded Paired-End Ditag (bPED) nucleic acid fragment constructs, each of which comprises a unique barcoded adaptor, a first tag, and a second tag linked to the first tag via the barcoded adaptor. The two tags are the 5′- and 3′-ends of a nucleic acid molecule from which they originate. The barcoded adaptor comprises a barcode, a first polynucleotide sequence comprising a first restriction enzyme (RE) recognition site, and a second polynucleotide sequence comprising a second RE recognition site and covalently linked to the first polynucleotide sequence via the barcode. The two REs lead to cleavage of a nucleic acid at a defined distance from their recognition sites. The length of the adaptor is set so that the bPED nucleic acid fragment fits one-step sequencing.

US20090154759 discloses method for generating a graphical code pattern from a multimedia content. The method comprises receiving one or more input and in response editing the multimedia content, encoding the multimedia content into a graphical code pattern, displaying the generated graphical code pattern, and concurrently with the editing, encoding the multimedia content into the graphical code pattern and displaying the image of the graphical code pattern, such as to provide a preview of the graphical code pattern. However, the method disclosed in this patent is not related to encoding the chemical structure in a barcode.

2D matrix barcodes like QRCode and PDF-417 are the obvious choice for more data accommodation and fast decoding. Few properties with corresponding maximum number of characters allowed are mentioned below in Table 1 to compare QRcode with PDF417.

TABLE 1
QRCode vs PDF417: Brief Comparison

| Sr no | Property | QRCode | PDF417 |
|---|---|---|---|
| 1. | Numeric | 7098 | 2710 |
| 2. | Alphanumeric | 4296 | 1850 |
| 3. | Binary | 2953 | 1018 |
| 4. | Kanji | 1817 | 554 |
| 5. | Scanner | Image Sensor | Image sensor mobile app |
| | | (Mobile App) | and High Resolution |
| | | | Linear Scan |
| 7. | Error Correction | Reed Solomon | Reed Solomon |

A paper published by the same inventor published in J. Chem. Inf. Model 2005, 45, 572-580, and referred to as Prior Art Document 1 hereinafter, discusses a 2-D barcode representation of molecular structures in Simplified Molecular Input Line Entry System (SMILES) format that enables a user to read and input molecular structures into computer systems in a fully automated fashion. The molecular structures are stored in SMILES format. Alternately, ACS format can be used for structural representation. To accommodate more data, LZW compression is used. The steps are as follows:
(i) Chemical structures are barcoded from SMILES or ACS format.
(ii) The barcodes from ACS format are generated by the Internet Compatible Barcoding Programs, and are tested by SCANTEAM 3400 CCD Long Range barcode scanner, whereas PDF417 barcode are tested and optimized using Welch Allyn 4410 image scanner.

The disclosure in said publication facilitates the storage of small macromolecules upto the size of several hundred atoms in a barcode format. However, only PDF417 is used for encoding chemical structure.

No attempt till date has been made for encoding complete compound library in a barcode and thus needs to be prototyped. The present invention enables to store virtual library, consisting of hundreds and thousands of molecules, in any commercially or freely available barcode.

### SUMMARY OF INVENTION

It is an objective of the present invention to provide a way to store virtual library of large number of molecular structures in a single barcode. Such a large data can be stored in any of the popular barcode formats, such as PDF417, QRcode, or any other barcode etc.

Therefore, the present invention discloses a method for encoding a large scale molecular data into a barcode which entails:
a) accessing the molecular input data or a series of chemical compound structures;
b) sorting and enlisting scaffolds, linkers and building blocks of the molecular data and rank them based on frequency of occurrence;
c) compressing enlisted scaffolds, linkers and building blocks;
d) adding action fingerprints;
e) compressing already compressed scaffolds, linkers, building blocks along with the action fingerprints into a specific location for transfer over a web for decoding;
f) feeding data obtained in from step a) to e) into the barcode.

Preferably, the data compression method is a pattern based method.

The present invention also discloses a method of decoding a large scale molecular data from a barcode comprising:
a) reading the barcode using a barcode reading device and disclosing action fingerprint;
b) generating an image containing virtual molecules by referring to enlisted scaffolds, linkers, building blocks;
c) mapping color coded molecule identifiers (Ids) onto said image; and
d) restructuring a molecule from said image.

In another embodiment, the present invention discloses the barcode reading device.

### BRIEF DESCRIPTION OF DRAWINGS

FIG. 1 illustrates workflow for the generation of virtual library with various enumeration options from a given set of large molecules.

FIG. 2a illustrates Five Components of a Barcode

FIG. 2b illustrates Logical compression using repeat pattern substitution

FIG. 2c illustrates Lempel-Ziv-Welch encoding of content mentioned in FIG. 2b

FIG. 2d illustrates Shortened URL

FIG. 2e illustrates Compression Ratio derived using our approach

FIG. 3 illustrates decoding of the barcode

FIG. 4 illustrates Plot of Data size reduction by systematic compression and encoding.

FIG. 5 illustrates a barcode reading device to decode virtual library from the barcode (PDF417 in this figure).

FIG. 6 illustrates barcodes encoded with 3292 virtual molecules.

FIG. 7 illustrates barcodes encoded with 12 virtual molecules.

### DETAILED DESCRIPTION

The present invention is fully described hereinafter with the help of drawings, including flowchart. However, it is to be noted that the drawings are for demonstrative purposes only and do not limit the scope of the invention. Any modification in the embodiment may be viewed by the person skilled in the art as within the scope of the invention.

Accordingly, the present invention discloses a method for encoding a large scale molecular data into a barcode, which consists of accessing the molecular data; generating, sorting and enlisting scaffolds, linkers and building blocks of the molecular data and rank them based on frequency of occurrence; compressing enlisted scaffolds, linkers and building blocks; generating action fingerprints; compressing already compressed scaffolds, linkers, building blocks along with action fingerprints into a specific location; feeding data obtained in from above steps into the barcode.

The present invention also discloses a method of decoding a large scale molecular data from a barcode, which comprises reading the barcode using a barcode reading device and disclosing action fingerprint; generating an image containing virtual molecules by referring to enlisted scaffolds, linkers, building blocks; mapping color coded molecule identifiers (Ids) onto the image; and restructuring a molecule from the image; finally prioritizing molecules as part of further screening.

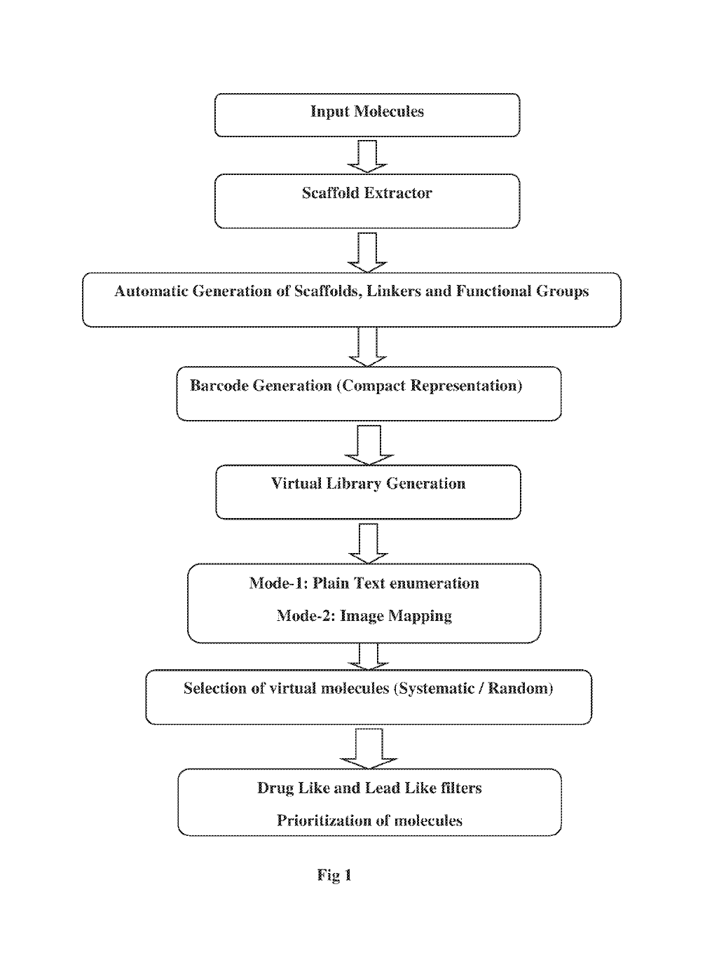

The method of the present invention is described in detail hereinafter. The complete workflow of the present invention is illustrated in FIG. 1.

### Encoding Process:

The encoding process starts with accessing the available data of molecules or molecular structures. During the process, three types of molecules are generated; i.e. scaffold, linker, building block, thus pulling out core structures from the complete one. The generated core molecules represent the whole input dataset, since top ranking scaffolds, linkers and building blocks are selected based on their frequency of occurrence in the complete list thus obtained. The ranking of the scaffold, the linker and the building block is dependent on the frequency of occurrence. These scaffolds have repetitive patterns of characters which are further reduced by substituting it with a set of special characters never found in structures represented in SMILES format. The data is subjected to a compression technique using ASCII character substitution for most common pattern repetitions like c or C occurring twice or thrice and other such combinations. The compression includes assigning said characters to subparts or repetitive regions of scaffolds, linkers and building blocks. The current implementation substitutes common patterns such as cc,ccc,CC,CCC,([R1-10]),[A],[C@@H],[C@H],c1,C1,Cc with special characters *?;|& ̂_˜><Y respectively. These ASCII characters for replacing common occurrences are chosen such that there is never a conflict between them and characters used in SMILES format. Thus, this technique compresses raw smiles considerably.

The above mentioned technique, which performs compression of scaffolds, linkers and building blocks, is called as “logical data compression” or “Logical Pattern based compression”. The data along with an action fingerprint is packed inside a barcode. The action fingerprint stored inside the barcode is a 4 bit fingerprint used to identify the molecular data. The action fingerprint directs taking of an appropriate action in a decoding process explained later. In the present invention, the action is set to select randomly few numbers of virtual molecules along with molecular properties.

TABLE 2
Description of action fingerprints

| Action | Fingerprints |
|---|---|
| Expand to Virtual Library with full enumeration | 0000 |
| Expand to Virtual Library with partial enumeration for | 0001 |
| 10 random molecules | |
| Expand to Virtual Library with partial enumeration for | 0010 |
| 100 random molecules | |
| Expand to Virtual Library with partial enumeration for | 0011 |
| 1000 random molecules | |
| Expand to Virtual Library with partial enumeration | 0100 |
| for 10000 random molecules | |
| Expand to Virtual Library with No enumeration and map | 0101 |
| it to an image for storage and dynamic retrieval | |
| of virtual molecules. | |

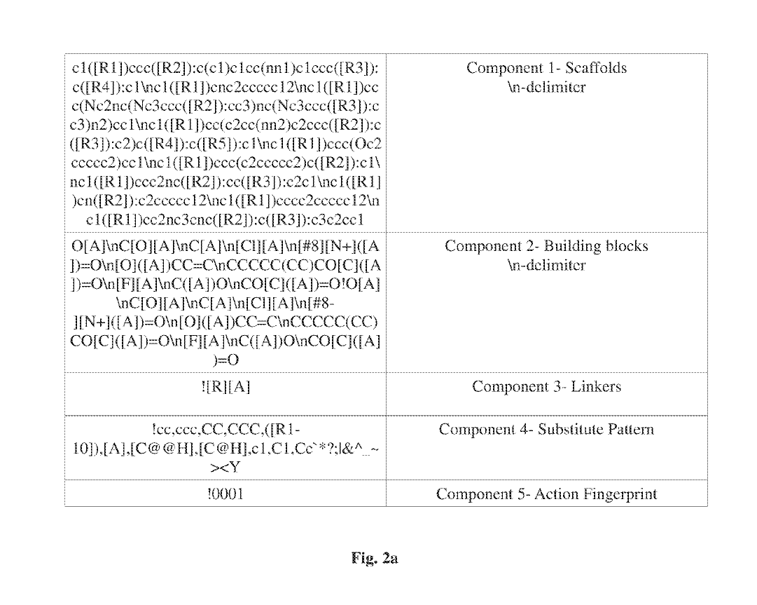

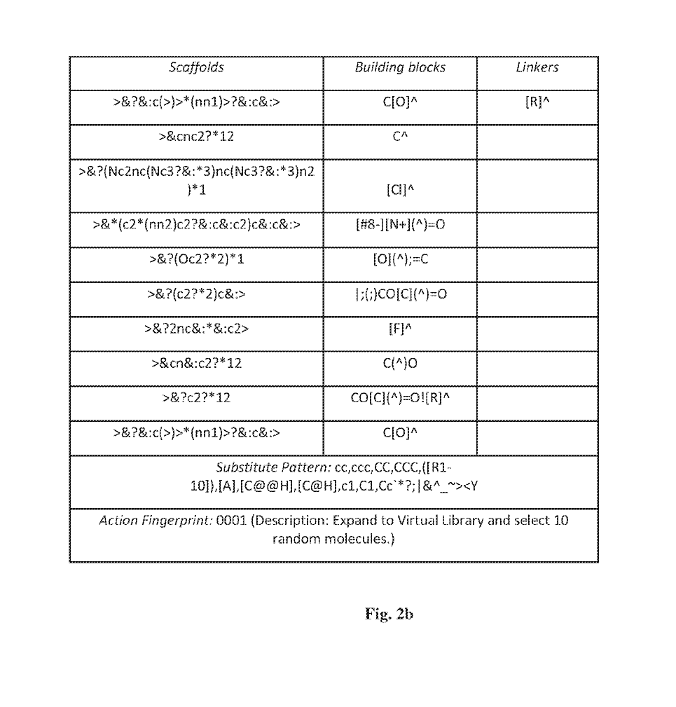

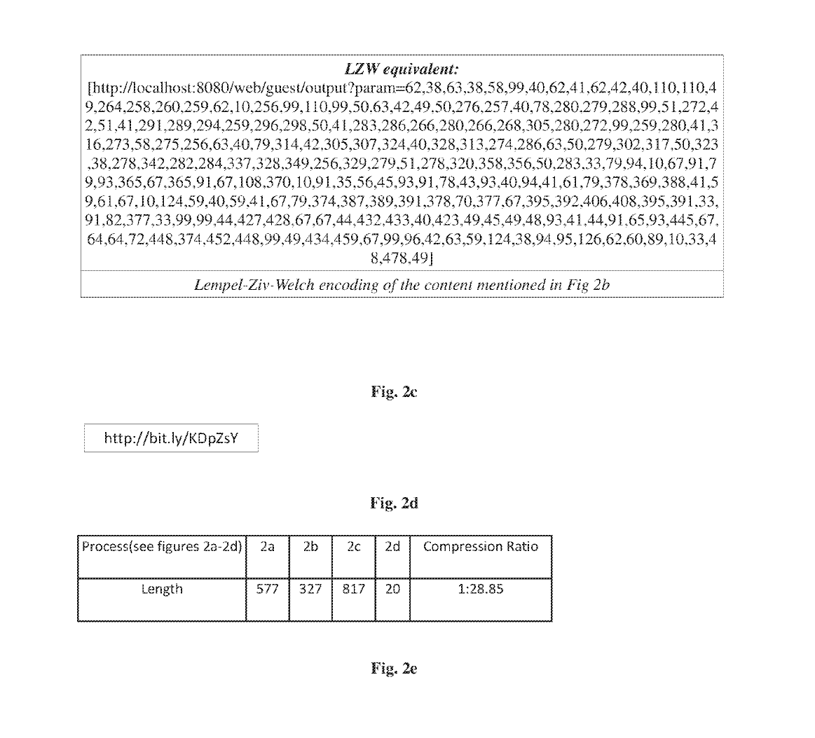

In yet another embodiment, before packing everything in a barcode, the logically compressed data is packed into a specific location; say a small URL or Uniform Resource Locator, to process it over web using a web server, after subjecting it to a lossless data compression method. The lossless data compression may be LZW compression, as LZW is composed of integers and ensures that URL does not contain any special characters for interpretation by a web browser. At this stage, a compact barcode has been generated and can be stored or immediately processed. This marks the end of the encode process refers to FIG. 2a-2d. The barcode may be PDF417. QRCode or any other commercially available barcode.

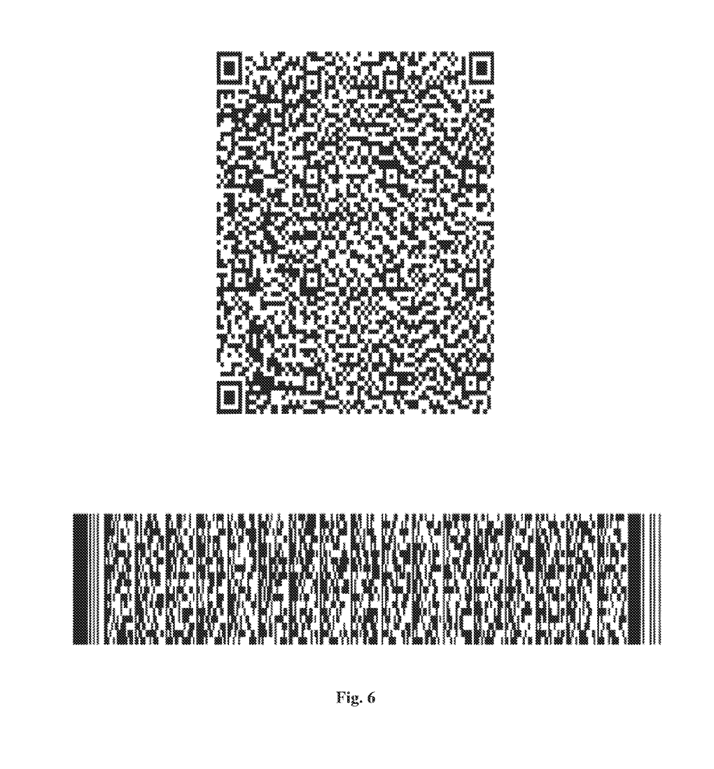

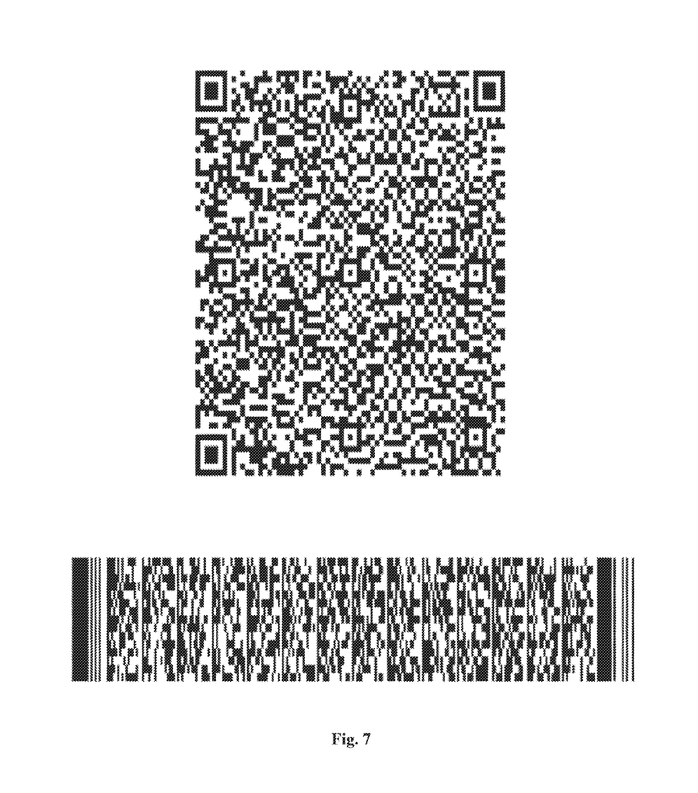

The “pattern based compression” or LZW compression method used in the present invention increases the storage from 327 bytes of compressed data to 819 bytes. This is essential as the use of special characters is incompatible with later URL generation for automatic barcode scanning. But this is compensated with URL shortening scheme by achieving compression ratio of 28.85 when tested on 10 scaffolds and 10 building blocks of total length 327 originally of length 577 bytes refers FIG. 2e. The pattern based compression converted to short URL is then encoded in a barcode. Also, relatively large barcodes can also be used for standalone application without passing it over to the web, shown in FIG. 6 encoding 3292 virtual molecules and in FIG. 7 encoding 12 virtual molecules.

### Decoding Process:

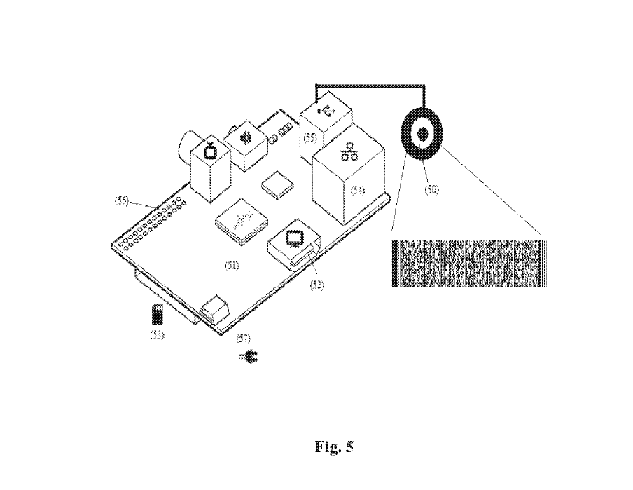

The decoding process starts with reading the data from the barcode thus generating a list of scaffolds, linkers and building blocks. The data is read using a barcode reading device. The barcode reading device may be a webcam, a mobile camera or any optical device or an image sensor. FIG. 5 illustrates internal composition of the barcode reading device. The barcode reading device has an optical device (FIG. 5: 50) which captures the barcode image. The optical device (FIG. 5: 50) is connected to a USB (FIG. 5: 55). A slot is provided for insertion of data storage device such as memory card (FIG. 5: 53), more particularly secure digital (SD) card. The barcode reading device has also been provided with 512 MB of RAM with processing unit or processor (51) including, but not limited to, graphical processor. In addition, barcode reading device has been provided with a General purpose input output (GPIO) pin (56) and a LAN slot (54).

The action fingerprint is subsequently revealed which triggers a prompt action to generate virtual molecules. The ingredients of the virtual molecules are, as stated above, scaffolds, linkers and building blocks.

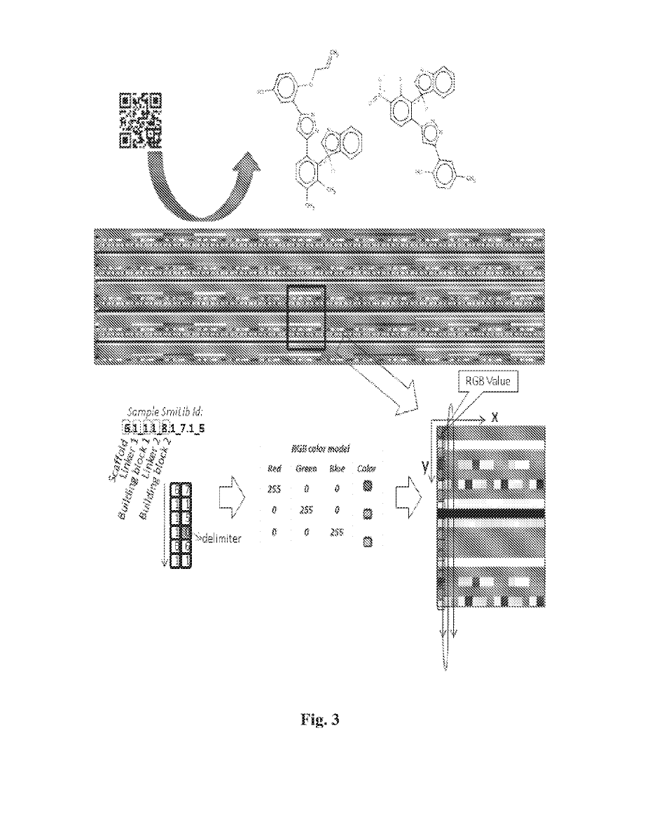

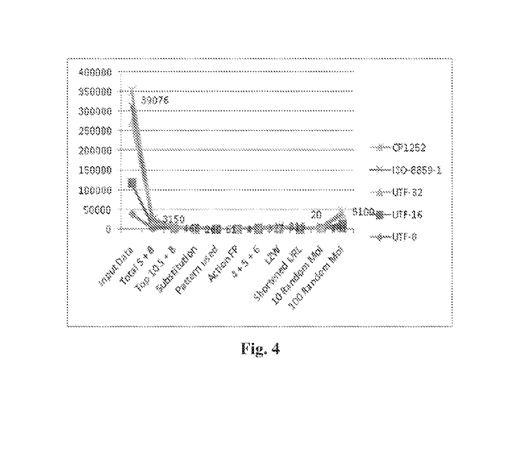

The next step is to enumerate the molecules. Enumeration is the process when virtual molecules are created in their complete form which is humanly readable. However, the virtual reaction when enumerated is time consuming. Therefore, the decoding method of the present invention implements partial enumeration instead. In the partial enumeration, only molecule identifiers (Ids) are retained. Subsequently, a defined structure of these identifiers is exploited to convert them in the form of images by mapping each component of the identifier which together represents a compound onto the pixels serially. At this stage, a colored image is generated as every component in the identifier is mapped on the image as unique colored pixels. This single image encapsulates all the molecules contained in the virtual space of the said comprehensive virtual reaction. As a result, the virtual library can be stored in the form of this particular image. Thus, these barcode formats are said to contain the reference to the complete virtual library representing hundreds and thousands of molecules, but the image generated is also storing the molecular data. Further, image is read pixel by pixel to reconstruct a molecule back from the image as illustrated in FIG. 3.

Identifiers in a defined format are mapped on to an image in a 1920×1080 image resolution using specifications of RGB colour model. A distinct colour is uniquely identified for a particular occurrence of scaffold, linker or building block. RGB Colour Model used is an additive colour model using three beams of red, green and blue light. Each beam is a component having its own arbitrary intensity ranging from 0 to 255. i.e. 0 to 2ⁿ−1, where n=8. Zero intensity for all three components adds black whereas full intensity for all makes white. If one of these components is with strongest intensity, the colour produced is hued nearing to this particular primary colour and if two components are with full intensity, the colour is hued close to its secondary colour. A total of 2⁸ combinations and 256 values in the range of 0 to 255 are available, from which unique RGB values are arbitrarily chosen for each chemical component. Alternately, 2²⁴ distinct colours can be produced using the said colour model and is very promising in any further extension of the approach.

In a virtual reaction, Identifiers are created using combinatorial possibilities but without enumerating molecules. These Identifiers have a fixed format of linker and building block id separated by underscore ‘_’ and such many pairs separated by period “.” which as a whole is preceded by scaffold id and separated again by period “.”. For example, the id 6.1_1.1_8.1_7.1_5 signifies that scaffold number 6 from the list with corresponding combinations of linker and building block pairs should be used to perform a virtual reaction while enumerating or defining a molecule in a standard chemical data format. Further, if there is a scaffold with four variable sites and four building blocks while keeping [R][A] as the default linker, the possible number of combinations can explode up to 1×4×4×4×4 molecules. Thus, it is implied that for 10 scaffolds with 10 Building blocks and further depending on the variable sites within each scaffold molecule, the chemical space to be explored is tremendously huge. To restrict the chemical space, the linker molecule has been used which is a glue between scaffold and building blocks. The Ids are encoded in an image with each component of the id represented by a particular pixel colour. A unique colour code is used for each occurrence of an identifier. Each component of Ids may be assigned a unique colour of RGB model. Table 3 explains reference color code table using RGB colour model and FIG. 3 pictorially explains minute details of ID-based image mapping.

TABLE 3
Colour coding scheme

| Scaffold/ | | | |
|---|---|---|---|
| Linker/Building | Component | | |
| block ID | Red | Green | Blue |
| 1 | 255 | 0 | 0 |
| 2 | 0 | 255 | 0 |
| 3 | 0 | 0 | 255 |
| 4 | 255 | 255 | 0 |
| 5 | 255 | 0 | 255 |
| 6 | 0 | 255 | 255 |
| 7 | 255 | 255 | 255 |
| 8 | 128 | 128 | 128 |
| 9 | 64 | 64 | 64 |
| 10 | 32 | 32 | 32 |
| 0 (delimiter) | 0 | 0 | 0 |

The combination can be extended to 256×256×256 possible combinations using RGB model. Later, the image is decoded or read pixel by pixel and RGB values are retrieved to reconstruct the molecule. This is the point when virtual library is enumerated after few molecules are randomly sampled from the image. The number of random molecules picked up is specified by the user before generating a barcode and is encoded as action fingerprint. This directs decoding mechanism to take appropriate action, details of which are given in Table 2 and FIG. 3. Zxing is an open source java library used in this project for generating and decoding QRCode and PDF417.

### Example

The test for encoding and decoding was carried on flavonoids, a class of plant derived natural product polyphenolic compounds known for their antibacterial properties. Flavonoids are a rich source of pharmacologically and biologically active components with tremendous value in novel drug discovery. When tested on 39,076 bytes of flavonoid dataset which consist of 790 compounds, the method of present invention successfully compressed the data to 819 bytes of its equivalent LZW code and finally in a barcode in the form of shortened URL which is just 20 bytes, as illustrated in FIG. 4 and enlisted in Table 4. The example is thus a prototyping of encoding complete virtual library data consisting of 1, 13, 230 molecules in a barcode as well as a bit map image for communication and storage purposes.

TABLE 4
Different stages of barcoding process with corresponding
bytes used for various charsets.

| Sr | | | | | ISO- | |
|---|---|---|---|---|---|---|
| No | Description | UTF-8 | UTF-16 | UTF-32 | 8859-1 | CP1252 |
| 1. | Input Data | 39076 | 78154 | 156304 | 39076 | 39076 |
| 2. | Total Scaffolds + | 3150 | 6302 | 12600 | 3150 | 3150 |
| | Building Blocks | | | | | |
| 3. | Top 10 Scaffolds + | 466 | 934 | 1864 | 466 | 466 |
| | Building Blocks | | | | | |
| 4. | Substitution | 260 | 522 | 1040 | 260 | 260 |
| 5. | Pattern string used | 61 | 124 | 244 | 61 | 61 |
| 6. | Action Fingerprint | 4 | 10 | 16 | 4 | 4 |
| 7. | 4 + 5 + 6 | 327 | 656 | 1308 | 327 | 327 |
| 8. | LZW (Lempel Ziv | 819 | 1640 | 3276 | 819 | 819 |
| | Welch | | | | | |
| | Compression) | | | | | |
| 9. | Shortened URL | 20 | 42 | 80 | 20 | 20 |
| 10. | 10 Random | 481 | 964 | 1924 | 481 | 481 |
| | Molecules | | | | | |
| 11. | 100 Random | 5100 | 10202 | 20400 | 5100 | 5100 |
| | Molecules | | | | | |

1. A method for encoding a large scale molecular data of a virtual-library into a barcode, the method comprising:
a) accessing a virtual-library of molecular data representing a plurality of molecules;
b) sorting and enlisting scaffolds, linkers and building blocks within the molecular data and ranking them based on frequency of occurrence;
c) compressing enlisted scaffolds, linkers and building blocks at least based on subparts or repetitive regions therein;
d) generating action fingerprints to cause an identification of selected molecules in said library during a decoding of the barcode;
e) compressing already compressed scaffolds, linkers, building blocks along with the action fingerprints into a specific location; and
f) feeding data obtained in steps a) to e) into the barcode for representing said virtual-library of the large-scale molecular-data.

2. The method of encoding according to claim 1, wherein the compression of enlisted scaffolds, linkers, building blocks is done by a logical data compression.

3. The method of encoding according to claim 2, wherein the logical data compression comprises of assigning special characters to the subparts or the repetitive regions of scaffolds, linkers and building blocks.

4. The method of encoding according to claim 1, wherein the action fingerprint is 4-bit string in a fingerprint form to identify the molecular data.

5. The method of encoding according to claim 1, wherein the barcode is selected from PDF417, QRCode or any other barcode.

6. A method of decoding a virtual-library of large scale molecular data from a barcode, said method comprising:
a) reading the barcode using a barcode reading device and disclosing action fingerprint, wherein said barcode represents said virtual-library of the large-scale molecular-data and said action-fingerprint represents a plurality of selected molecules to be identified within said library;
b) generating an image containing a plurality of virtual molecules by referring to enlisted scaffolds, linkers, building blocks;
c) mapping color-coded molecule identifiers (Ids) onto said image; and
d) restructuring one or more molecule from said image based on said mapping, said restructured molecules corresponding to said selected-molecules represented by said action-fingerprint.

7. The method of decoding according to claim 6, wherein the barcode reading device comprises an optical device (50), a processing unit (51), and a data storage device (53).

8. The method of decoding according to claim 7, wherein the optical device (50) is selected from a webcam, a mobile camera or any such device.

9. The method of decoding according to claim 6, wherein each component of the Ids is assigned a unique colour of RGB model.

10. The method of decoding according to claim 6, wherein said image is read pixel by pixel to reconstruct the molecule.
